(19) United States
(12) Patent Application Publication
(10) Pub. No.: US 2026/0034706 A1
(43) Pub. Date: Feb. 5, 2026

(54) METHOD AND PLANT FOR THE PRODUCTION OF MATERIAL BOARDS AND A MATERIAL BOARD

(71) Applicants: DIEFFENBACHER GMBH MASCHINEN- UND ANLAGENBAU, Eppingen (DE); LUSO FINSA INDUSTRIA E COMERCIO DE MADEIRAS, S.A., Nelas (PT)

(72) Inventors: Carlos Antonio Ferreira FORTUNA, Nelas (PT); Carlos Rial PEREZ, Nelas (PT); Daniel SCHWARTZE, Eppingen (DE); Frank HEYMANNS, Eppingen (DE); Florian KNÖRZER, Eppingen (DE); Jan PHILIPP, Eppingen (DE)

(73) Assignees: DIEFFENBACHER GMBH MASCHINEN- UND ANLAGENBAU, Eppingen (DE); LUSO FINSA INDUSTRIA E COMERCIO DE MADEIRAS, S.A., Nelas (PT)

(21) Appl. No.: 19/355,642

(22) Filed: Oct. 10, 2025

Related U.S. Application Data
(63) Continuation of application No. PCT/EP2024/059921, filed on Apr. 11, 2024.

(30) Foreign Application Priority Data
Apr. 11, 2023 (DE) 102023001422.2

(51) Int. Cl. B27N 3/08; B27N 3/18; B27N 3/24

(52) U.S. Cl. CPC B27N 3/086; B27N 3/18; B27N 3/24

(57) ABSTRACT

A method and a plant for the production of material boards from at least one material which is spread to form a press mat and mixed with at least one binder curable by heat and/or pressure. The press mat is compressed in a double belt press with steel belts warmer than the press mat, and is heated by heat conduction. At least one cover layer resting against a steel belt is heated to a temperature above the curing temperature of the binder and cured at least partially. The uncured parts of the press mat are heated and cured in a downstream injection press by introducing tempered fluids to a temperature above the curing temperature of the binder. Fluids are introduced into or through the press mat through one or both cover layers. Also provided are a material board produced by a method and/or in such a plant.

### CROSS-REFERENCE TO RELATED APPLICATIONS

This application is a continuation of International Patent Application No. PCT/EP2024/059921, filed Apr. 11, 2024, which claims priority to German Patent Application No. 102023001422.2, filed Apr. 11, 2023, the entire disclosures of which are incorporated by reference herein.

### FIELD

The invention relates to a method for the production of material boards from a material spread to form a press mat.

The invention also relates to a plant for the production of material boards.

In addition, the invention relates to a material board produced by the above method or in the above plant.

### BACKGROUND

The following discussion is provided to aid the reader in understanding the disclosure and is not admitted to describe or include prior art thereto.

The production of material boards by pressing free-flowing or scattered material in calender, intermittent or double belt presses is known state of the art. Mixtures of materials containing lignocellulose, such as wood, woody plants or annual plants, are spread in one or more layers with or without binders and cured as press mats with pressure and/or heat to form stable material boards. The material boards can be flexible or pliable (thin MDF boards made of fibers) but still have a certain inherent rigidity against pressure. There are also material boards for furniture construction, mostly particle boards (or multi-layered and laminated with foil) or so-called coarse particle boards (OSB) made from flat chips. Substitution with plastics, waste wood or other fillers is common.

For production, the materials are mixed with a binder, usually methylene diphenyl isocyanate (MDI) or polymeric methylene diphenyl isocyanate (pMDI), urea-formaldehyde resins (UF) or melamine-reinforced urea-formaldehyde resins (MUF), or other curable adhesives.

Press mats can be produced or spread in single or multiple layers. Particle boards are usually multi-layered and, optionally, also spread in a classified manner, so that the coarse material is arranged in the flat center plane between the surface sides and cover layers of fine material lie on one or both surface sides. OSB boards are also multi-layered, but usually have differently oriented layers and can also vary in material size accordingly.

There are also combination boards in a multi-layer design, for example internal particle layers with externally disposed fiber layers as cover layers. Externally disposed fiber layers or particle layers are now also used in OSB production.

### SUMMARY

The spreading or production of the press mat is known from the prior art and can be regarded as largely independent of the present method. The single-layer or multi-layer production of the press mat essentially influences the material board as a product. The necessary settings in the individual devices of the plant or in the method are made depending on the press mat, the material used, its moisture, the layer structure and the like in order to achieve the desired quality of a material board.

Previous press systems in double belt design are usually more than 20 m long and require an overall complex setup for heating, pressure generation and load flow distribution in the press frame. In addition, it is complex in terms of control technology to operate a double belt press properly over such lengths. Errors or problems during operation can cause considerable damage and downtime. Furthermore, the steel construction and control technology itself is complex and can usually only be operated and maintained by specialists.

The development of these long and large presses was due to the glue liquors and binders used in the past. Progress and the necessary improvement in terms of environmental compatibility have led to further leaps in development in this area, so that new binders are characterized by or require a different setting behavior in terms of pressure, temperature and exposure time.

It is the object of the present invention to create a method and a plant that makes it possible to avoid the above disadvantages. In particular, it should be possible to divide the previous complex plant technology of long and large plants into subsections which may be less susceptible to failure or damage. In addition, a material board is to be created that can also be produced with a high quality on a simplified system. In particular, it should be possible to produce the material board at a lower cost, especially in terms of investment costs and manufacturing costs.

In an extension of the object, it should be possible to improve the production speed and quality for the existing binders, in particular for aminophenol-based binders (UF, MUF, MUPF, PF, UFMP). It should also be possible to use bio-based binders (tannins and mixed polymers, animal and vegetable proteins, lignins and mixed polymers, carbohydrate-containing binders) as well as PVA, acrylics, epoxy or MDI with advanced properties.

The invention is essentially based on a continuous method for the production of material boards, in which material spread to form a press mat, which is mixed at least with a binder that can be cured by heat and/or pressure, is cured.

The object of the invention is solved for the method in that the press mat is compressed continuously in a double belt press with steel belts which are warmer than the press mat and is heated by thermal conduction,
wherein at least one cover layer which is close to the surface or adjacent to a steel belt is heated to a temperature above the curing temperature of the binder and this is cured at least partially,
wherein the uncured parts of the press mat, in particular the uncured middle layer, are heated and cured in a downstream injection press by introducing tempered fluids to a temperature above the curing temperature of the binder,
wherein the fluids are introduced into or through the press mat through one or both cover layers.

Surprisingly, the invention has now recognized that it is possible to significantly reduce the previously known effort for continuously operating double belt presses with a length of 25 m and more by using the heavy double belt press essentially only for at least partial curing of the cover layers, whereas the main part of the curing of the press mat or the middle layer can be carried out by a pure injection press. This reduces, for example, excessively long steel belts and rolling supports as well as the corresponding effort required to guide and control them.

In particular, it was recognized that it is possible to inject heated fluids such as steam, hot air or similar into the press mat in order to cure the middle layer and subsequently obtain a fully cured material board with sufficient quality properties, despite partially or fully cured cover layers.

The invention understands partially or fully cured to mean a part of the press mat or the cover layer which is inherently or dimensionally stable and essentially no longer changes, even if chemical or physical reactions continue to take place in it. As a result, although fluids can escape into or out of the mat when the cover layers are cured or almost cured, a resilient or decompressive behavior of the middle layer after the double belt press or in the transition to the injection press does not damage the press mat or the subsequent product per se.

The invention has thus recognized, among other things, that partially cured or cured cover layers are partly elastic and also sufficiently continuous that they do not burst open due to internal steam overpressure after board production, as is the case with conventional surface bursts. Usually, there is even a cooling effect or a reduction in the internal pressure of the press mat because cool ambient air can flow into the press mat in a decompression area or the volume of the middle layer or the press mat increases.

In a particular exemplary embodiment, the invention even proposes that the decompressing press mat is offered an environment with hot or tempered fluid, preferably without moisture content, after the double belt press and before or at the start of the injection press. This measure can further accelerate the production process in an advantageous way. The environment can be realized, for example, by a chamber or enclosure that excludes the environment or by injection plates that provide a sufficient amount of fluid for absorption by the press mat, which increases in volume.

When a chamber or type of enclosure is arranged, the volume-demanding opening of the press mat creates a vacuum in the area surrounding the press mat, so that sealing does not have to be absolutely tight as long as sufficient fluid is provided in this enclosure.

Optionally, decompression can also be supported by actively introducing fluid, for example by overpressure. The opening gradient can be set in a controlled manner in order to avoid cracks in the surface layers or inside the press mat.

Alternatively or additionally, the method can be carried out in such a way that the subsequent compression area is used to substitute the missing volume when decompressing the press mat. Either the air flowing outwards against the transport direction or in the decompression area is taken up again by the press mat and/or the compression area displaces the excess volume against the transport direction within the press mat in the direction of the decompression area.

In an advantageous way, tempered fluids could alternatively or additionally be introduced in the compression area and the existing volume within the press mat could be displaced into the decompression area against the production direction and/or in order to increase the temperature in the middle layer already here.

Fluids can also be supplied, injected and/or extracted at the narrow sides. Generally accompanying or diametrically opposed to the processes on the surface sides. With regard to the compression and/or decompression area, extreme sealing of the chamber or enclosure only seems necessary in individual cases. Rather, walls, optionally with flexible seals or friction-reducing elements, are sufficient to provide adequate shielding from the environment, for example above or next to the circulating belts. Air leakage can be regulated by appropriate pressure control within the chamber or enclosure.

The following definitions and references are useful for understanding the invention and its teachings:

Surface sides are the flat sides of a press mat or material board that come into contact with the belts, whereas the narrow sides represent the thickness or height of the press mat or material board. The outer surface sides contain the cover layers to be at least partially cured by the double belt press.

The invention deals with the curing of a cover layer on the outer surface sides by the continuously working double belt press. This cover layer to be at least partially cured is not to be confused with a layer structure or the spreading of cover layers from the technology of press mat production or the designation in the case of multi-layer press mats. Any type of one or multi-layer press mat can be used in the present method or plant. For example, the near-surface scatter layers of a press mat can be at least partially cured in the course of the method in the double belt press, whereby these layers are interpreted according to the invention as “one” at cover layer to be at least partially cured, which leaves the double belt press relatively dimensionally stable, whereas the middle layer is not dimensionally stable and, in the decompression area after the surface pressure from the double belt press is no longer present, springs up again or increases in volume. The aforementioned middle layer can also consist of several different (scatter) layers, but is defined here as the area which has not yet reached the temperature required to initiate the setting process of the binder near the center plane of the press mat.

In sum the use of the word “layers” cured or hardened in the plant or by the method in the described invention is not referring to the different stratified layers of a mat, but merely symbolizes the thickness of cured areas adjacent to the steel belts of the double belt press or the middle (area) of the mat in the injection press. Of course, it might be possible, that three stratified layers of a three layer mat is aligning coincidentally with the cured cover layers and the middle layers.

Another exemplary alignment might happen in a mat with five stratified layers, whereas the cover layers are cured and the middle layer consists out of the three remaining layers in the middle of the mat.

Of course it is also possible that only a part of a spread outer layer of a multi layered mat is cured by thermal conduction in the double belt press or the other way around one or more spread layers are cured by thermal conduction, which are in both ways referred to as “cover layer” according to the invention.

Therefore the uncured area in the middle of the mat after the double belt press can comprise or can consist out of a part of a spread middle layer, a spread middle layer as a whole or several layers spread before the press.

According to the invention a spread one layered material mat consisting only out of one material (combination), e.g. fibers, can be produced as well, whereas one or both outer areas of such a one layered mat are cured as one or two cover layers and whereas the rest of the uncured areas are cured by or in the injection press.

In the special case, that only one surface is heated to establish a cured cover layer the invention is referring to the uncured middle layer or uncured remaining material as middle layer.

In addition to the temperature, the humidity or a similar physically detectable limit value can also be used as a threshold value (starting value) for the setting process, as some binders do not react only or at all to the temperature, but also require a certain level of humidity or other basic conditions for the setting process to proceed chemically correctly.

Technologically, the depth of curing or the thickness of the at least partially cured surface layers is essentially determined by the transfer time or steel belt speed, the type of material, the temperature of the steel belts and/or the curing temperature of the binder, respectively these are the technological parameters that should be taken into account or adjusted during production.

The invention also understands compression in the double belt press to mean the mere surface contact of the steel belts with the press mat for heat transfer, which would physically at least require an approximate “compression”, even if only infinitesimally.

The invention understands a material board to be an (almost) completely cured press mat. In the nature of things, this emerges from the plant or the individual devices as a strand and is divided into material boards by diagonal saws, which are not shown in detail but are common, and later optionally cooled and stacked.

The belts used in the injection press can be made of a steel that is thin compared to the double belt press or of a heat-resistant plastic that is not damaged by the high radiation temperature of the steel belts of the double belt press. The belts have openings for the passage and/or distribution of the fluid.

The upper and lower belts in the individual devices, if present, are preferably of the same design at the top and bottom and are guided accordingly around deflection or drive rollers.

The double belt press can be designed as an isobaric press, but also as a conventional continuous press with rolling elements (e.g. rolling bar carpet) arranged between the heating plates and the steel belts. Usually, the heating plates, which are used for the heat supply, are heated with a hot fluid that flows through the heating plates.

In order to make the structure of the plant according to the invention somewhat clearer, the individual machines of the device can also be named as: prepress (optional), cover layer press (double belt press), injection press (curing) and calibration press (optional).

In the case of a prepress, it should be noted that although optional heating according to the prior art is preferably carried out during deaeration, curing will not or cannot take place in the press mat, as the curing temperature of the binder should not be reached. Usually it is the intention to control or regulate the method or the plant that the curing temperature is approached as near as possible.

With respect to curing temperature, the invention means a temperature at which the binder begins to react chemically and changes into a dimensionally stable reticulated or plasticized state. This reaction is irreversible with most binders, provided that it has been initiated by sufficient starting energy.

The cover layers cured in the cover layer press are used to facilitate the transport of the press mat, but also to cover the press mat in order to minimize springback when switching between the double belt press and the injection press. This creates a certain bulk density profile across the thickness of the press mat. Nevertheless, it is possible or even sensible to provide options between the individual devices that control or even deliberately enable springback in order to create certain production conditions, for example to facilitate the introduction of fluids into the press mat due to the negative pressure in the press mat during decompression.

In addition to the procedural advantages of the invention, the following features include further properties that can be combined as desired to improve the method or the plant:

Heated air, steam, preferably superheated steam, or a steam-air mixture can be used as a tempered fluid. These fluids have already proven their worth in the past for heating a press mat upstream of a main press.

Preferably, with unsaturated air or a steam-air mixture, the dew point can be set so that the moisture contained in the fluid only condenses after entering the cover layer or after passing through a cover layer in the press mat. This prevents water stains or rupturing of the cover layer.

Alternatively, it can be provided that a limit temperature and/or a water content is reached in the middle layer by the fluids, which is suitable for causing the binder to cure, preferably until the material board emerges from the injection press. In addition to the limit temperature, there are other physical limit values that activate curing, for example the water content present, the pressure and/or, optionally, a hardener concentration that is achieved by adding hardener agent to the fluid.

In the double belt press, a pressing pressure of more than 1 or 2 N/mm² can be applied to the press mat. Preferably, the pressing pressure should not exceed 6 N/mm². A lower pressure may also be possible. This may be indicated for thermal insulation boards or lightweight boards.

After leaving the double belt press, an at least cured cover layer should have a thickness of more than 1 mm, preferably more than 2 mm and most preferably 3 mm to 4 mm, so that there is sufficient inherent rigidity or dimensional stability.

Liquid and/or hardener agent can be applied to the surface side of the press mat for the binder. This can have a positive effect on the through-curing or speed of the surface layers. The application is normally carried out shortly before the press from below and/or from above.

An anti-caking agent can be applied to a steel belt of the double belt press and/or to a surface side of the press mat before contact with the double belt press so that the cover layer does not stick or adhere to the steel belt when leaving the double belt press and possibly lead to ruptures in the middle layer and/or at the transition of the cover layer or middle layer.

The thickness of the at least partially cured cover layer can be determined after the press mat exits the double belt press. A non-destructive testing method can be arranged for this purpose.

These and other settings or regulations in the plant or for carrying out the method can be used in a control or regulation device in order to implement or optimize the method according to the invention and/or to operate the plant. Preferably, the values are used in a control or regulation system for adjusting the double belt press or the thickness of the cover layer.

In the injection press, press mat can be pressed with a surface pressure of less than 0.75 N/mm², preferably less than 0.6 N/mm² and most preferably with a surface pressure or pressing pressure of less than 0.5 N/mm².

Alternatively or cumulatively, flat injection plates and/or perforated rollers with covers for areas not facing towards the press mat with openings for guiding and dispensing the fluid can be used to introduce the fluid into the press mat.

In an advantageous application, the fluid is introduced into the press mat at a pressure of more than 0.5 bar, preferably approx. 1.5 bar, most preferably more than 2 bar. The value can also be determined and/or set as the fluid exits or enters the injection plates.

The press mat can be guided through the injection press with at least one permeable belt on one side of the surface, in particular for passing the fluid through it. The belt can be designed as a perforated metal or plastic belt, as a woven belt or as a chainmail belt.

The belts can be compressed together with the press mat in the injection press or in the transport direction upstream of the injection press by a compressing unit or a calender and/or subjected to a thrust force in the transport direction, preferably by the calender or the drive rollers of the injection press.

After the middle layer of the material board has cured, it can be compressed and/or held in a calibration press between two belts, preferably steel belts, to the nominal dimension, preferably with a surface pressure or a pressing pressure of less than 2.5 N/mm².

It is preferable that the cover layers of the material board are smoothed, heated and/or cooled in the calibration press.

The waste heat extracted in the calibration press due to a cooling process can be reused. A heat pump, a heat exchanger or other low-temperature appliance in active connection with the calibration press is preferably provided for this purpose. It is particularly preferable that the waste heat can be used in parts of the plant in the transport direction upstream of the calibration press.

The material boards to be produced preferably have a nominal thickness of more than 8 mm, preferably more than 30 mm and most preferably more than 60 mm. Solid boards are preferably produced with a thickness of up to 80 mm.

Defective press mats or material boards, particularly those that are not provided with the necessary curing, can be disposed of in a waste container after the injection press or after the calibration press. This protects the finishing process for material boards with diagonal saws, sanding units and/or transport rollers from fragile, partially hardened material boards. Before entering the double belt press, the produced or spread mat can be subjected to pre-compression in a prepress for deaeration. Preferably, it is deaerated there with at least one air-permeable fabric belt and most preferably not preheated.

Depending on the process application, the material board cured in the injection press or emerging from the injection press can be subjected to a tractive force in the transport direction. This can be done, for example, by the drive rollers of the injection press, by the calibration press or by a separate calender.

A control or regulating device can be used to control or regulate the speed of production or the individual plant parts, preferably the double belt press, the injection press and/or the calibration press. Preferably, a master-slave system is controlled or regulated for this purpose, in which only one individual device is provided as the master or reference variable. Preferably, the curing injection press or the double belt press or its production speed is used.

Preferably, a single-layer or multi-layer, preferably a three-layer or a five-layer, press mat is used in the plant or for the method, which is suitable for the production of an MDF, an HDF, a particle board, an OSB (chipboard), a mixed board made of fibers and chips, wherein the fibers are preferably arranged in the outer layers, or a thermal insulation board.

It is also possible to use a press mat to produce a thermal insulation board with only one or both outer layers.

At least proportionally aminophenol-based binders, methylene diphenyl isocyanate (MDI), polymeric methylene diphenyl isocyanate (pMDI), urea-formaldehyde resins (UF), melamine-reinforced urea-formaldehyde resins (MUF), bio-based resins, preferably tannins with or without mixed polymers, vegetarian and/or animal proteins, lignins with or without mixed polymers, carbohydrate-containing binders, PVA, acrylic and/or epoxy-based resins can be used as the curable binders in the press mat.

Due to the method and/or the plant, an intermediate area is formed between the two presses, the double belt press and the injection press, in which the press mat switches in a guided or unguided manner from one press to the next. Mostly, a compressed press mat will increase in volume after the double belt press, as the behavior of the middle layer is elastic due to the lack of curing of the binder in the middle layer and the binder cannot contribute to plasticization.

In this way, the press mat or the uncured middle layer can be aerated or spring back in a decompression area after leaving the double belt press, wherein a tempered fluid can be made available in this decompression area to the press mat on at least one surface side and/or the narrow sides for incorporation into the press mat. This can be achieved by flooding the area surrounding the expanding press mat with the fluid. To reduce the effort involved, flooding can preferably be carried out in a chamber, an enclosure or a suitable tunnel in this area. In addition to being provided, the press mat can also be actively pressurized with the fluid, for example with an overpressure in the chamber, enclosure or tunnel.

After the double belt press, the press mat can be compressed in a compression area, preferably on the inlet side in the injection press. It is preferably provided that in this compression area, the tempered fluid of the press mat is injected on at least one surface side and/or is passively absorbed on a surface side, most preferably on the opposite surface side.

In a particularly preferred and independent exemplary embodiment, the press mat is compressed in the double belt press to 0 to 20%, preferably to 0 to 10% and most preferably to +/−5% above the nominal dimension of the material board during the production of the cover layers. In other words, the compression in the double belt press corresponds to up to 120%, preferably up to 110%, and most preferably 95% to 105% of the height of the finished material board.

In a further differentiated embodiment, the springback is limited to less than 25%, preferably less than 15%, particularly less than 10% after the double belt press.

In addition to the classic layers built up symmetrically to the center plane of the press mat or material board, it may also be provided that only one cover layer is at least partially or completely cured and the uncured middle layer or its area extends to the other side of the surface. Press mats of this type are produced in particular in the manufacture of flexible or relatively rigid thermal insulation boards, especially those based on natural fibers. However, MDF boards, for example for furniture back panels, also frequently have a smooth and compacted surface on one (surface) side, whereas the other side corresponds to the middle or residual layer.

In addition or as an alternative to the described options for injecting the fluids, further alternative designs are possible. For example, fluids can be injected and extracted in alternating cycles along the transport direction. The fluids can be injected into the press mat on one side and extracted on the other. This process can take place alternately or in cycles in the transport direction at predetermined intervals. The narrow sides can be incorporated into the fluid guide with positive or negative pressure.

Material used for the press mat can comprise pure and/or mixtures of lignocellulosic materials, such as natural wood, recycled wood, woody plants, waste wood, plant residues and/or annual plants. Filler materials can be added as necessary, especially for lightweight boards.

The object for a plant for the production of material boards from at least one material which is spread to form a press mat and which is mixed with at least one binder which can be cured by heat and/or pressure, is solved in such a way that a double belt press with two endlessly circulating steel belts for compressing and heating the press mat and for at least partially curing at least one layer or cover layer resting against a steel belt by heating to above the curing temperature of the binder is arranged in the transport direction of the press mat, and an injection press having at least one means for injecting tempered fluids into one of the surface sides of the press mat for tempering and curing the uncured parts of the mat or the middle layer is arranged downstream of the double belt press.

The process engineering features and positive improvements already listed for the method can be used in unison for a plant with the aforementioned features.

In an advantageous manner, the individual features listed in the table below can be cumulated with these or with the following advantageous features, combined as desired or independently improve the solution of the plant or the method:
Preferred means for injecting tempered fluids are injection plates, injection rollers or injection nozzles, preferably with openings for providing preferably heated air, steam, superheated steam and/or a steam-air mixture.
An anti-caking agent application for applying an anti-caking agent to a steel belt of the double belt press and/or an additive application for applying additives and/or water to the press mat upstream of the double belt press can be arranged.
One or two endlessly circulating belts can be arranged in the injection press. These are preferably designed as a perforated metal or plastic belt, a woven belt or a chainmail belt.
A compression unit and/or a calender can be arranged in or adjacent to the injection press.
A calibration press and/or a discharge container can be arranged downstream of the injection press. A discharge container can also be arranged downstream of the calibration press, either as a stand-alone unit or separately.
A semi-finished material board or an uncured press mat would not be suitable for being fed through the finishing process. A deflector can be arranged to force the hardened cover layers in the direction of the discharge container.
The calibration press for recycling waste heat from the material boards is operatively connected to a low-temperature appliance, preferably to a heat exchanger, a heat pump and/or parts of the appliance upstream of the calibration press. A low-temperature appliance is preferably suitable for utilizing a medium with a temperature of less than 60°, most preferably less than 40° C., in order to save energy.
A decompression area having a chamber, a tunnel, an enclosure and/or injection plates can be arranged between the double belt press and the injection press to provide temperature-controlled fluids for the press mat, which increases in volume.

The solution to the object of creating a new material board is solved by producing a material board using the method according to the invention and/or in a plant according to the invention.

In a separate and particularly preferred embodiment, the method or plant consists of three stages:
a) Curing on one or both sides, at least partially, in a double belt press;
b) Curing the remaining uncured areas or the middle layer in an injection or a steam press and
c) Calibration/adjustment of the thickness of the material board in a double belt press.

Finally, it should be pointed out once again that curing does not necessarily mean the complete and final chemical development of the entire binder. Rather, curing should be initiated or accelerated by exceeding the curing temperature, a temperature at which the binder (increasingly) reacts, so that further process or manufacturing steps can be carried out.

Such further process or manufacturing steps might be smothering the surface, calibrating the overall thickness, calibrating the different thickness of the layers and/or embossing the surface.

Another advantages may be obtained by using or combining the following features: The endless belts used in the injection press can be dried and/or cleaned via cleaning units in the return flow. This ensures that the quality of the compression and/or injection of the fluid into the press mat is consistent throughout. Such units for the circulating belts can also be arranged in the two other presses.

The injection plates might have openings for the fluid to be injected into the press mat. On the opposite side of the press mat, the injection plates can also introduce fluid or apply a corresponding vacuum to pass the fluid through the press mat. The introduction and heat dissipation of the fluid in the press mat cures the binder and a material board is then formed. The injection plates can be heated to prevent the formation of droplets or water due to condensation. Preheaters can be arranged for the circulating belts in any of the used presses.

Optionally, a calibration press can be arranged downstream of the injection press, which adjusts or recompresses the thickness of the material board using belts. The belts are preferably designed as steel belts. The steel belts can be cooled by cooling plates in order to further strengthen the material board. The steel belts can smooth the surface.

A discharge container can be arranged downstream of the injection press, which receives faulty sheets and/or incompletely cured material boards or press mats.

A deflector can be arranged to force the already cured cover layers in the direction of the discharge container. The discharge container can also be arranged after the calibration press or any press. The discharge containers normally have shredding means so that the discharged material can be transported further in shredded form.

Preferably the mentioned and used steel belts in the double belt press or the calibration press are impermeable. They might have an especially smooth surface. Hence the energy transfer is optimized and/or the surface of the cover layer is even or smoothened. A closed steel belt is most suitable to conduct the energy respectively the heat transfer to or from the mat or rather to the surface/cover of the mat. Depending on the expected temperature and necessary forces any kind of belt with heat conductive features is able to function as a steel belt. Therefore the steel or other belts should preferably be hermetically sealed or closed to penetrating fluids whereas in the calibration press there might be exceptions.

### BRIEF DESCRIPTION OF THE FIGURES

Further advantageous measures and designs of the object of the invention are apparent from the sub-claims and the following description with the drawing, wherein:

FIG. 1 shows a schematic side view of a consecutive arrangement of the double belt press and the injection press according to the invention with optional prepress in the front transport direction and optional calibration press in the rear transport direction, and

FIG. 2 in a further exemplary embodiment, a possible enlarged representation of an alternative transition between the double belt press and the injection press according to the invention.

Identical reference signs are generally used for identical or similar machine elements or device parts. In front of, in or opposite to the transport direction is understood by the invention in relation to a location or a direction in which a press mat, which is cured to form a material board, normally passes through the plant. The plant according to the invention consists of at least two individual presses, which together form the technical system for implementing the method.

### DETAILED DESCRIPTION

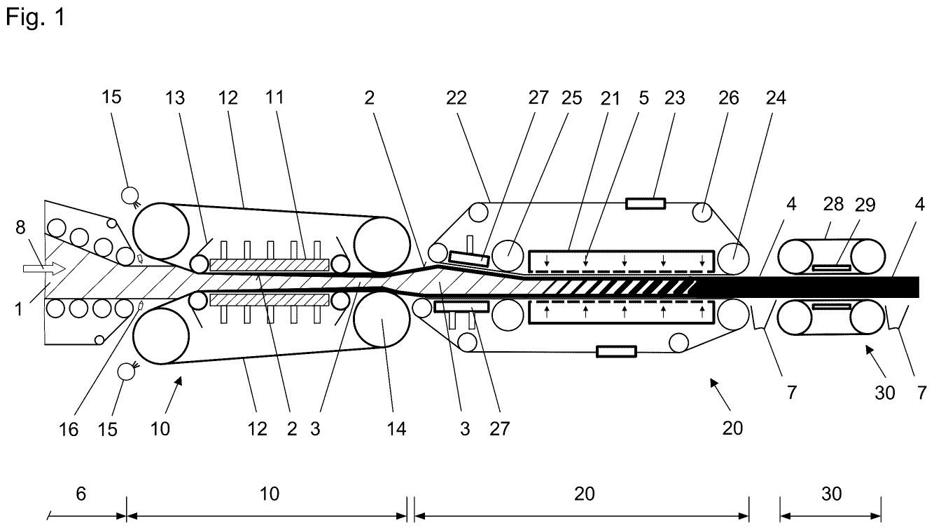

According to FIG. 1, a spread press mat 1 is transferred to a double belt press 10 in transport direction 8 by a transport device not shown further, usually a forming belt, which runs under spreading devices (not shown) to produce the press mat 1. Optionally, the press mat can be precompressed in a prepress 6 before this transfer in order to de-aerate it as far as possible.

In the course of compression or, optionally, without compression in the double belt press 10, heat is transferred after contact between the steel belts 12, which circulate endlessly over deflection drums 14, at the top and bottom with the press mat 1 and the cover layers 2 of the press mat 1 are cured. The depth of the curing or the thickness of the cover layers 2 is essentially determined by the transfer time/steel belt speed, the type of material, the temperature of the steel belts and/or the curing temperature of the binder. Heating plates 11 are arranged for heating the steel belts and the necessary press pressure, which can be subjected to force via a press frame using hydraulic cylinders (not shown) and can be raised and lowered. For rolling support of the steel belts 12 relative to the heating plates 11, a roller bar circulation system 13 can be arranged. An anti-caking agent applicator 15 can be arranged for applying an anti-caking agent to the steel belts 12. The anti-caking agent can also be applied to the surfaces or surface sides of the press mat. In addition, it is also conceivable to apply an additive or water to the surface sides of the press mat 1, for example to accelerate curing in the cover layers 2 or to create a vapor shock effect in the double belt press 10 through the overheated steel belts 11 in the direction of the middle layer 3. For this purpose, an additive application 16 or a water spray device can be arranged at a suitable location.

The partially cured press mat 1 is discharged from the double belt press 10 and then transferred to an injection press 20 together with the middle layer 3, which may have been heated but not yet cured. In the injection press 20, the press mat 1 is transported and guided by belts 22. The arranged injection plates 21 are used for curing the middle layer 3 or the not yet cured areas by providing tempered fluid 5 for the press mat 1. Instead of or together with the injection plates 21, known steam rollers (not shown) can be arranged, which roll on the press mat 1 or the belts 22 and are otherwise enclosed by metal sheets, so that the steam rollers, which are permeable to the fluid, only dispense the fluid 5 on the press mat side. The quantity or temperature of the fluid 5 is set so that the binder reaches the curing temperature in the entire cross-section of the press mat and begins to harden.

The belts 22 are guided endlessly via drive rollers 24 and are deflected as required via deflection rollers 26. A compression unit 27 can be arranged on the infeed side of the injection press 20, which can adjust the infeed or compression gradient for the press mat 1 via corresponding adjusting means (not shown). Additionally or alternatively, a calender 25 can also be arranged, which initiates the compression of the press mat 1 and ensures a corresponding reduction in friction of the belts 22 on the injection plates 21. The calender 25 can be arranged as desired and preferably depending on the process, for example between the double belt press 10 and the injection press 20, within the injection press 20 or after it, or between the injection press 20 and the optional calibration press 30. The belts 22 can be dried and/or cleaned via cleaning units 23 in the return flow. This ensures that the quality of the injection of the fluid 5 into the press mat 1 is consistent throughout. Cleaning units for the circulating belts can also be arranged in the two other presses.

The injection plates 21 have openings for the fluid 5 to be injected into the press mat 1, for example steam, hot air or superheated steam. On the opposite side of the press mat 1, the injection plates 21 can also introduce fluid 5 or apply a corresponding vacuum to pass the fluid through the press mat 1. The introduction and heat dissipation of the fluid in the press mat 1 cures the binder and a material board 4 is formed. The injection plates can be heated to prevent the formation of droplets or water due to condensation. Preheaters can be arranged for the circulating belts 22.

Optionally, a calibration press 30 can be arranged downstream of the injection press 20, which adjusts or recompresses the thickness of the material board 4 using belts. The belts are preferably designed as steel belts 28. The steel belts 28 can be cooled by cooling plates 29 in order to further strengthen the material board. The steel belts can smooth the surface.

A discharge container 7 can be arranged downstream of the injection press 20, which receives faulty sheets and/or incompletely cured material boards 4 or press mats 1. A deflector can be arranged to force the already cured cover layers 2 in the direction of the discharge container 7. The discharge container 7 can also be arranged after the calibration press. The discharge containers 7 normally have shredding means so that the discharged material can be transported further in shredded form.

In terms of method and process technology, the procedure for manufacturing a material board 4 would be summarized as follows:

A press mat 1 is produced and fed into a double belt press 10 in transport direction 8, where it is usually compressed and heated. The steel belts 12 are supported and heated by heating plates 11, which also transmit the pressing force. The heat transfer from the indirectly heated steel belts 12 heats the surfaces or surface sides of the press mat to such an extent that the binder in the surface layers 2, or at least one surface layer, begins to cure. The curing process is shown schematically by a black line that becomes thicker in the transport direction as part of the press mat 1. At the outlet of the double belt press, the press mat 1 expands, as the compressed middle layer 3 does not yet have a cured binder and the material of the middle layer 3 has been elastically compressed. The cover layers 2 are at least partially cured to such an extent that they are permeable to penetrating fluids or ambient air, but retain their optionally compressed shape. The press mat 1 with the at least partially cured cover layer 2 and an uncured middle layer 3 is transferred to an injection press 20, where it may optionally be compressed and shaped again and, in the course of the injection press 20, subjected to fluids 5 which ensure that the curing temperature or other threshold values required for curing the middle layer 3 are reached. The increasing curing in transport direction 8 over the length of the injection press 20 is shown with increasingly thicker hatching, which finally merges into a continuous black material board 4.

With reference to the directional arrows of the fluids 5, it should be noted that the introduction of the fluids 5 is shown in a simplified process. The introduction and/or discharge can take place alternately, alternating, pulsating or in other variants and should essentially already be known from the prior art in the course of the vaporization of press mat upstream of a double belt press in a prepress or the like.

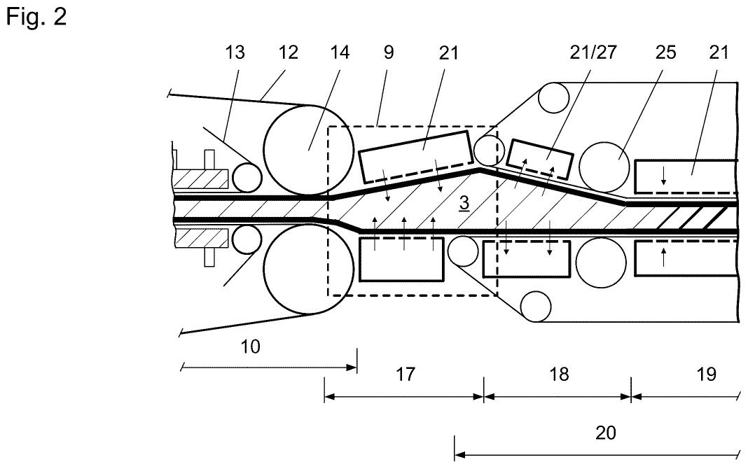

FIG. 2 shows a further preferred exemplary embodiment of the invention. Here, the decompression area 17 between the double belt press 10 and the injection press 20 as well as the compression area 18 and the curing area 19 within the injection press 20 are shown enlarged.

After the double belt press 10, the press mat 1 will (usually) increase its volume due to the elastic restoring forces in the middle layer 3, despite the almost fully cured cover layers 2. At the same time, ambient air will flow into the press mat 1 or into the middle layer 3 and, optionally, provide a cooling effect. This can be reduced by pressing countermeasures such as sliding shoes or rollers. However, it is preferable that the area surrounding the press mat 1 in the decompression area 17 is supplied with a correspondingly heated fluid, a different fluid or preferably the same fluid 5 as in the injection press 20. By enlarging, the press mat 1 absorbs the hot air or the tempered fluid 5 in the environment and is heated rather than cooled in the cover layers 2 and/or the middle layer 3. Subsequently, the press mat 1 is compressed again or transferred to the injection press 20 and compressed there in the compression area 18. Fluid 5 can be injected into the press mat again or for the first time, but preferably suitable compression units 27 ensure the necessary compression pressure and, optionally, specifically absorb or even extract the excess pressure when venting the press mat.

It is particularly preferable for a fluid to be introduced on one side through the compression unit 27 and discharged on the other side of the surface. The compression unit can also be provided with injection plates 21 or have calenders 25 with rotating rollers that can introduce or suck up/absorb fluids 5 in the direction of the press mat 1. For this purpose, the rollers are provided with openings on the circumference, wherein the rollers are covered with a plate on the circumference and the plate only has an opening in the direction of the press mat 1.

Alternatively or cumulatively, a frame or a chamber 9 or an enclosure can be arranged, which preferably encloses the end of the double belt press and the beginning of the injection press 10 or covers the decompression area 17. This chamber is shown clearly enlarged in FIG. 2 for optimum visualization. Alternatively, a tunnel can be provided here, in which the press mat 1 is fed through and the tunnel is or will be flooded with a fluid, which is absorbed by the press mat or the middle layer 3 due to the increase in volume in the decompression area 17. The fluid can also be absorbed or supported by the narrow sides of the press mat 1439.

### LIST OF REFERENCE SIGNS 1439

1. Press mat
2. Cover layer
3. Middle layer
4. Material board
5. Fluid
6. Prepress
7. Discharge container
8. Transport direction
9. Chamber
10. Double belt press
11. Heating plates
12. Steel belt
13. Roller bar circulation system
14. Deflection drum
15. Anti-caking agent application
16. Additive application
17. Decompression area
18. Compression area
19. Curing area
20. Injection press
21. Injection plates
22. Belt
23. Cleaning unit
24. Drive rollers
25. Calender
26. Deflection rollers
27. Compression unit
28. Steel belt
29. Cooling plate
30. Calibration press

1. Method for the continuous production of material boards from at least one material which is spread to form a flat press mat and which is mixed with at least one binder which can be cured by heat and/or pressure, whereas the mat can be spread as a one or multi horizontally stratified mat, characterized in that
the press mat (1) is compressed in a double belt press (10) with steel belts (12) which are warmer than the press mat (1) and is heated by thermal conduction, wherein at least one cover layer (2) resting against a steel belt (12) is heated to a temperature above the curing temperature of the binder and this is cured at least partially,
wherein the uncured parts of the press mat (1), in particular the uncured middle layer (3), are heated and cured in a downstream injection press (20) by introducing tempered fluids (5) to a temperature above the curing temperature of the binder,
wherein the fluids (5) are introduced into or through the press mat (1) through one or both cover layers (2).

2. Method according to claim 1, characterized in that heated air, steam, preferably superheated steam, or a steam-air mixture is used as the tempered fluid (5).

3. Method according to any one or more of the preceding claims, characterized in that, in the case of unsaturated air or a steam-air mixture, the dew point is set such that the moisture contained in the fluid (5) condenses in the press mat (1) only after entering the covering layer (2) or after passing through a covering layer (2).

4. Method according to any one or more of the preceding claims, characterized in that a limit temperature and/or a water content is reached in the middle layer (3) which is suitable for effecting curing of the binder, preferably until the material board emerges from the injection press (20).

5. Method according to any one or more of the preceding claims, characterized in that a pressing pressure of more than 2 N/mm² is applied to the press mat (1) in the double belt press (10) and preferably the pressing pressure does not exceed 6 N/mm².

6. Method according to any one or more of the preceding claims, characterized in that a cured cover layer (2), after leaving the double belt press (10), has a thickness of more than one mm, preferably of more than 2 mm and most preferably of 3 mm to 4 mm.

7. Method according to any one or more of the preceding claims, characterized in that liquid and/or hardener for the binder is applied to the surface side of the press mat (1) or an anti-caking agent is applied to a steel belt (12) and/or to a surface side of the press mat (1).

8. Method according to the preceding claim, characterized in that the thickness of the cured cover layer (2) is determined after the press mat (1) has emerged from the double belt press (10), preferably using a non-destructive testing method, and most preferably the values are used in a control or regulation system for adjusting the double belt press (10) or the thickness of the cover layer (2).

9. Method according to any one or more of the preceding claims, characterized in that in the injection press (20) the press mat (1) is subjected to a surface pressure of less than 1 N/mm², preferably less than 0.6 N/mm² and very particularly preferably to a pressure of less than 0.5 N/mm².

10. Method according to any one or more of the preceding claims, characterized in that flat injection plates (21) and/or perforated rollers with covers for areas not facing in the direction of the press mat (1) are used for introducing the fluid (5) into the press mat (1), with openings for guiding and discharging the fluid.

11. Method according to any one or more of the preceding claims, characterized in that the fluid is introduced into the press mat (1) at a pressure of more than 0.5 bar, preferably of about 1.5 bar, most preferably of more than 2 bar, and/or emerges from the injection plates (21).

12. Method according to any one or more of the preceding claims, characterized in that the press mat (2) is guided through the injection press (20) with at least one permeable belt (22) resting on one surface side for the passage of the fluid (5), wherein the belt (22) is preferably designed as a perforated metal or plastic belt, as a woven belt or as a chainmail belt.

13. Method according to any one or more of the preceding claims, characterized in that the belts (22) together with the press mat (1) are compressed in the injection press (20) in the transport direction (8) upstream of the injection press (20) by a compression unit (27) or a calender (25) and/or are subjected to a thrust force in the transport direction (8), preferably by the calender (25) or the drive rollers (24).

14. Method according to any one or more of the preceding claims, characterized in that, after curing of the middle layer (3), the material board (4) is compressed and/or held in a calibration press (30) between two steel belts (28) to the nominal dimension, preferably with a pressure of less than 2.5 N/mm².

15. Method according to any one or more of the preceding claims, characterized in that the cover layers (2) of the material board (4) are smoothed, heated and/or cooled in the calibration press (30).

16. Method according to any one or more of the preceding claims, characterized in that the waste heat extracted in the calibration press (30) as a result of a cooling process is reused, preferably in a heat pump, a heat exchanger or in other low-temperature appliances, wherein the waste heat is used particularly preferably in parts of the plant in the transport direction (8) upstream of the calibration press (30).

17. Method according to any one or more of the preceding claims, characterized in that the material boards (4) are produced with a nominal thickness of more than 8 mm, preferably more than 30 mm and most preferably more than 60 mm, wherein solid material boards of up to 80 mm are preferably produced.

18. Method according to any one or more of the preceding claims, characterized in that after the injection press (20) or uncured press mats (1) are disposed of in a discharge container (7).

19. Method according to any one or more of the preceding claims, characterized in that the press mat (1) is subjected to pre-compression in a prepress (6) for deaeration before entering the double belt press (10), preferably there with at least one air-permeable fabric belt and most preferably not tempered.

20. Method according to any one or more of the preceding claims, characterized in that the material board (4) cured in the injection press (20) or emerging from the injection press (20) is subjected to a tractive force in the production direction, preferably by the drive rollers (24) of the injection press (20), by the calibration press (30) or by a separate calender (25).

21. Method according to any one or more of the preceding claims, characterized in that the speed of the production or of the individual plant parts, preferably of the double belt press (10), the injection press (20) and/or the calibration press (30), is controlled or regulated in a master-slave system by a control or regulating device, wherein the injection press (20) or its production speed is preferably used as the master or as the reference variable.

22. Method according to any one or more of the preceding claims, characterized in that a single-layer or multi-layer, preferably three-layer or five-layer, press mat (1) is used, which is suitable for the production of an MDF, an HDF, a particle board, an OSB (chipboard), a mixed board made of fibers and chips, wherein the fibers are preferably arranged in the outer layers, or a thermal insulation board.

23. Method according to any one or more of the preceding claims, characterized in that at least proportionally aminophenol-based binders, methylene diphenyl isocyanate (MDI), polymeric methylene diphenyl isocyanate (pMDI), urea-formaldehyde resins (UF), melamine-reinforced urea-formaldehyde resins (MUF), melamine-formaldehyde resins (MF), bio-based resins, preferably tannins with mixed polymers, vegetarian and/or animal proteins, lignins with mixed polymers, carbohydrate-containing binders, PVA, acrylic and/or epoxy-based resins can be used as the curable binder in the press mat (1).

24. Method according to any one or more of the preceding claims, characterized in that the press mat (1) or the uncured middle layer (3) is aerated or springs back in a decompression area (17) after leaving the double belt press (10), wherein a tempered fluid (5) is made available in this decompression area (17) to the press mat (1) on at least one surface side and/or the narrow sides for incorporation into the press mat (1).

25. Method according to any one or more of the preceding claims, characterized in that the press mat (1) is compressed after the double belt press (10) in a compression area (18), preferably on the inlet side in the injection press (20),
wherein the tempered fluid (5) of the press mat is preferably injected on at least one surface side in this compression area (18) and/or is passively picked up or extracted on one, most preferably on the opposite, surface side.

26. Method according to any one or more of the preceding claims, characterized in that the press mat material comprises pure and/or mixtures of lignocellulosic materials, such as natural wood, recycled wood, woody plants, waste wood, plant residues and/or annual plants, whereas preferably filler materials can be added.

27. Plant for the continuous production of material boards from at least one material which is spread to form a flat mat of press material and which is mixed with at least one binder which can be cured by heat and/or pressure, whereas the mat can be spread as a one or multi horizontally stratified mat, characterized in that a double belt press (10) with two endlessly circulating steel belts (12) for compressing and/or heating the press mat (1) and for at least partially curing a cover layer (2) resting against a steel belt (12) by heating to above the curing temperature of the binder is arranged in the transport direction (8) of the press mat (1), and an injection press (20) having at least one means for injecting tempered fluids (5) into one of the surface sides of the press mat (1) for tempering and curing the uncured parts of the mat or the middle layer (3) is arranged downstream of the double belt press (10).

28. Plant according to the preceding claim, characterized in that injection plates (21) or injection nozzles are arranged as means for injecting tempered fluids (5), preferably with openings for providing preferably heated air, steam, superheated steam and/or a steam-air mixture over a large area.

29. Plant according to any one of the preceding plant claims, characterized in that an anti-caking agent applicator (15) for applying an anti-caking agent to a steel belt (12) of the double belt press (10) or to the press mat (1) and/or an additive application (16) for applying additives and/or water to the press mat (1) is arranged upstream of the double belt press (10).

30. Plant according to any one of the preceding plant claims, characterized in that one or two endlessly circulating belts (22) are arranged in the injection press (20), preferably a perforated metal or plastic belt, a woven belt or a chainmail belt.

31. Plant according to any one of the preceding plant claims, characterized in that a compression unit (27) and/or a calender (25) is arranged in or adjacent to the injection press (20).

32. Plant according to any one of the preceding plant claims, characterized in that a calibration press (30) and/or a discharge container (7) is arranged downstream of the injection press (20) and/or a discharge container (7) is arranged downstream of the calibration press (30).

33. Plant according to any one of the preceding plant claims, characterized in that the calibration press (30) is arranged with a heating and/or a cooling system for the mat respectively the board and is preferably operatively connected to a low-temperature appliance for recycling waste heat from the material boards (4), preferably to a heat exchanger, a heat pump and/or parts of the plant upstream of the calibration press (30).

34. Plant according to any one of the preceding plant claims, characterized in that a decompression area (17) having a chamber (9), a tunnel, an enclosure and/or injection plates is arranged between the double belt press (10) and the injection press (20) to provide tempered fluids (5) for the press mat (1), which increases in volume.

35. A material board, preferably produced by a method according to any one or more of the preceding method claims and/or produced in a plant according to any one or more of the preceding plant claims.
